(19) United States
(12) Patent Application Publication
(10) Pub. No.: US 2025/0043053 A1
(43) Pub. Date: Feb. 6, 2025

(54) ACTIVE ENERGY RAY-CURABLE RESIN COMPOSITION, CURED PRODUCT, LAMINATE, AND ARTICLE

(71) Applicant: DIC Corporation, Tokyo (JP)

(72) Inventors: Akio UMINO, Chiba (JP); Naoto INOUE, Chiba (JP)

(73) Assignee: DIC Corporation, Tokyo (JP)

(21) Appl. No.: 18/714,572

(22) PCT Filed: Oct. 20, 2022
(86) PCT No.: PCT/JP2022/039036

§ 371 Date: May 30, 2024

(30) Foreign Application Priority Data
Dec. 21, 2021 (JP) 2021-206928

(51) Int. Cl. C08F 222/10; C08F 2/44; C08F 2/50; C08J 7/04; C08J 7/043; C08K 3/22; C08K 3/36; C08K 5/07; C08K 9/04

(52) U.S. Cl. CPC C08F 222/103; C08F 2/44; C08F 2/50; C08J 7/0427; C08J 7/043; C08K 3/22; C08K 3/36; C08K 5/07; C08K 9/04; C08J 2333/08; C08J 2345/00; C08K 2003/2244; C08K 2201/005; C08K 2201/011

(57) ABSTRACT

The present invention provides an active energy ray-curable resin composition including inorganic microparticles (A) having a (meth)acryloyl group on a particle surface, inorganic microparticles (B) other than the inorganic microparticles (A), a compound (C) having two or more (meth)acryloyl groups in one molecule, and a photopolymerization initiator (D), in which a total content of the inorganic microparticles (A) and the inorganic microparticles (B) is in a range of 40 to 90% by mass in a total mass of the inorganic microparticles (A), the inorganic microparticles (B), and the compound (C). This active energy ray-curable resin composition has excellent substrate adhesion and excellent scratch resistance in a cured product.

### TECHNICAL FIELD

The present invention relates to an active energy ray-curable resin composition, a cured product, a laminate, and an article.

### BACKGROUND ART

Resin materials having a (meth)acryloyl group can be easily and instantly cured by an irradiation with an active energy ray or the like and have excellent transparency, hardness, and the like of cured products, and therefore are widely used in the field of paints, coating agents, and the like. The objects to be coated are very diverse, including optical films, plastic molded products, wood products, and the like, and the performance requirements vary depending on the types, applications, and the like of the objects to be coated, and therefore, many resins designed according to the purposes have been proposed.

As resin materials having a (meth)acryloyl group, an active energy ray-curable type resin composition containing a (meth)acryloyl group-containing acrylic resin, pentaerythritol tetraacrylate, and pentaerythritol triacrylate is known (see, for example, PTL 1). However, although a cured product of the active energy ray-curable type resin composition has an excellent balance between surface hardness and low curing shrinkage and is useful as a coating agent for coating relatively thin plastic films as a target to be coated, there was a problem in that the cured product has low adhesion to the film substrate, especially low adhesion after an accelerated lightfastness test assuming a practical usage situation, and therefore peeling is likely to occur.

Therefore, materials having excellent substrate adhesion even after an accelerated lightfastness test and having excellent scratch resistance that can be used as a coating agent were being sought.

### CITATION LIST

### Patent Literature

PTL 1: Japanese Unexamined Patent Application Publication No. 2011-207947

### SUMMARY OF INVENTION

### Technical Problem

An object of the present invention is to provide an active energy ray-curable resin composition having excellent substrate adhesion and excellent scratch resistance in a cured product thereof, a cured product, a laminate, and an article.

### Solution to Problem

As a result of diligent study to solve the above problems, the inventors of the present invention have found that the above problems can be solved by using an active energy ray-curable resin composition including inorganic microparticles having a (meth)acryloyl group on a particle surface, inorganic microparticles other than the above-mentioned inorganic microparticles, a compound having two or more (meth)acryloyl groups in one molecule, and a photopolymerization initiator, leading to the completion of the present invention.

That is, the present invention encompasses the following aspects.

[1] An active energy ray-curable resin composition including inorganic microparticles (A) having a (meth)acryloyl group on a particle surface, inorganic microparticles (B) other than the inorganic microparticles (A), a compound (C) having two or more (meth)acryloyl groups in one molecule, and a photopolymerization initiator (D), in which a total content of the inorganic microparticles (A) and the inorganic microparticles (B) is in a range of 40 to 90% by mass in a total mass of the inorganic microparticles (A), the inorganic microparticles (B), and the compound (C).

[2] The active energy ray-curable resin composition according to [1], in which the inorganic microparticles (A) and the inorganic microparticles (B) are each independently silica and/or zirconium oxide.

[3] The active energy ray-curable resin composition according to [1] or [2], in which a content of the inorganic microparticles (A) is in a range of 10 to 90% by mass in a total mass of the inorganic microparticles (A) and the inorganic microparticles (B).

[4] The active energy ray-curable resin composition according to any one of [1] to [3], in which the compound (C) has the number of (meth)acryloyl groups in a range of 2 to 6.

[5] The active energy ray-curable resin composition according to [1], in which the compound (C) is a compound represented by the following general formula (1):

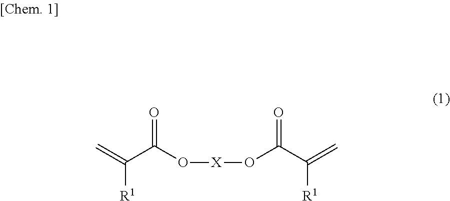

wherein R¹s each independently represent a hydrogen atom or a methyl group, and X represents an alkylene chain having 6 or more carbon atoms.

[6] A cured product of the active energy ray-curable resin composition according to any one of [1] to [5].

[7] A laminate having a cured coating film of the active energy ray-curable resin composition according to any one of [1] to [5] on one or both sides of a substrate.

[8] The laminate according to [7], in which the substrate is a cyclic olefin-based substrate or a linear olefin-based substrate.

[9] The laminate according to [7] or [8], in which the substrate is in a film form.

[10] An article including the laminate according to any one of [7] to [9] on its surface.

### Advantageous Effects of Invention

An active energy ray-curable resin composition of the present invention has excellent substrate adhesion and scratch resistance, and therefore, can be used as coating agents or adhesives, and in particular, can be suitably used as coating agents.

### DESCRIPTION OF EMBODIMENTS

An active energy ray-curable resin composition of the present invention includes inorganic microparticles (A) including a (meth)acryloyl group on a particle surface, inorganic microparticles (B) other than the inorganic microparticles (A), a compound (C) having two or more (meth)acryloyl groups in one molecule, and a photopolymerization initiator (D).

In the present invention, the term “(meth)acryloyl” means acryloyl and/or methacryloyl. The term “(meth)acrylate” means acrylate and/or methacrylate. The term “(meth)acrylic” means acrylic and/or methacrylic.

As the inorganic microparticles (A), those having a (meth)acryloyl group on a particle surface are used.

Examples of commercially available products of the inorganic microparticles (A) include “MEK-AC-2140Z”, “MEK-AC-4130Y”, “MEK-AC-5140Z”, “PGM-AC-2140Y”, “PGM-AC-4130Y”, “MIBK-AC-2140Z”, and “MIBK-SD-L” manufactured by Nissan Chemical Corporation, and “V-8802” and “V-8804” manufactured by JGC Catalysts and Chemicals Ltd. These inorganic microparticles (A) can be used alone or in combination of two or more kinds.

As the inorganic microparticles (A), since the active energy ray-curable resin composition capable of forming the cured product having excellent substrate adhesion and scratch resistance can be obtained, the inorganic microparticles preferably have an average primary particle diameter in a range of 1 to 120 nm. In the present invention, the average primary particle diameter is obtained by measuring the diameter of a plurality of inorganic microparticles by transmission electron microscope or scanning electron microscope and calculating the average value.

Examples of the inorganic microparticles (A) include zirconium oxide, silica, barium sulfate, zinc oxide, barium titanate, cerium oxide, alumina, titanium oxide, niobium oxide, zinc oxide, tin oxide, tungsten oxide, and antimony. These inorganic particles can be used alone or in combination of two or more kinds. Among these, silica and zirconium oxide are preferred since the active energy ray-curable resin composition capable of forming the cured product having excellent substrate adhesion and scratch resistance can be obtained.

The content of the inorganic microparticles (A) is preferably in a range of 10 to 90% by mass and more preferably in a range of 10 to 60% by mass in the total mass of the inorganic microparticles (A) and the inorganic microparticles (B), since the active energy ray-curable resin composition capable of forming the cured product having excellent substrate adhesion and scratch resistance can be obtained.

As the inorganic microparticles (B), inorganic microparticles other than the inorganic microparticles (A) are used. That is, inorganic microparticles without (meth)acryloyl groups on the particle surface are used.

Examples of the inorganic microparticles (B) include zirconium oxide, silica, barium sulfate, zinc oxide, barium titanate, cerium oxide, alumina, titanium oxide, niobium oxide, zinc oxide, tin oxide, tungsten oxide, and antimony. These inorganic microparticles can be used alone or in combination of two or more kinds. Among these, silica and zirconium oxide are preferred since the active energy ray-curable resin composition capable of forming the cured product having excellent substrate adhesion and scratch resistance can be obtained.

Examples of commercially available products of the inorganic microparticles (B) include IPA-ST, IPA-ST-L, IPA-ST-ZL, EG-ST, PGM-ST, DMAC-ST, MEK-ST-40, MEK-ST-L, MEK-ST-ZL, MIBK-ST, MIBK-ST-L, CHO-ST-M, EAC-ST, PMA-ST, and TOL-ST, manufactured by Nissan Chemical Corporation.

As the inorganic microparticles (B), wet-dispersed nanosilica or the like obtained by wet-dispersing fumed silica in a wet type bead mill or the like can also be used.

Examples of fumed silica include “AEROSIL 7200”, “AEROSIL 8200”, “AEROSIL 9200”, and “AEROSIL #200” manufactured by NIPPON AEROSIL CO., LTD.

The total content of the inorganic microparticles (A) and the inorganic microparticles (B) is preferably in a range of 40 to 90% by mass and more preferably in a range of 45 to 65% by mass in the total mass of the inorganic microparticles (A), the inorganic microparticles (B), and the compound (C), since the active energy ray-curable resin composition capable of forming the cured product having excellent substrate adhesion and scratch resistance can be obtained.

As the (meth)acrylate compound (C), those having two or more (meth)acryloyl groups in one molecule are used.

Examples of the compound (C) include bifunctional (meth)acrylates such as 1,6-hexanediol di(meth)acrylate, 1,4-butanediol di(meth)acrylate, 1,3-butylene glycol di(meth)acrylate, 1,9-nonanediol di(meth)acrylate, 1,10-decanediol di(meth)acrylate, neopentyl glycol di(meth)acrylate, ethylene oxide-modified 1,6-hexanediol di(meth)acrylate, hydroxypivalic acid neopentyl glycol di(meth)acrylate, propylene oxide-modified neopentyl glycol di(meth)acrylate, tripropylene glycol di(meth)acrylate, dipropylene glycol di(meth)acrylate, triethylene glycol di(meth)acrylate, ethylene oxide-modified di(meth)acrylate of bisphenol A, propylene oxide-modified di(meth)acrylate of bisphenol A, ethylene oxide-modified di(meth)acrylate of bisphenol F, tricyclodecane dimethanol di(meth)acrylate, tetraethylene glycol di(meth)acrylate, polyethylene glycol di(meth)acrylate, polypropylene glycol di(meth)acrylate, propylene oxide-modified tri(meth)acrylate of glycerin, 2-hydroxy-3-acryloyloxypropyl (meth)acrylate, ethylene oxide-modified di(meth)acrylate of bisphenoxyethanol fluorene, polytetramethylene glycol di(meth)acrylate, ethoxylated isocyanuric acid tri(meth)acrylate, phenoxyethylene glycol (meth)acrylate, stearyl (meth)acrylate, 2-(meth)acryloyloxyethyl succinate, trifluoroethyl(meth)acrylate, 3-methyl-1,5-pentanediol di(meth)acrylate, 2,3-[(meth)acryloyloxymethyl]norbornane, 2,5-[(meth)acryloyloxymethyl]norbornane, 2,6-[(meth)acryloyloxymethyl]norbornane, 1,3-adamantyl di(meth)acrylate, 1,3-bis[(meth)acryloyloxymethyl]adamantane, tris(hydroxyethyl) isocyanuric acid di(meth)acrylate, 3,9-bis[1,1-dimethyl-2-(meth)acryloyloxyethyl]-2,4,8,10-tetraoxospiro[5.5]undecane, trimethylolpropane di(meth)acrylate, pentaerythritol di(meth)acrylate, dipentaerythritol di(meth)acrylate, and ditrimethylolpropane di(meth)acrylate;
trifunctional (meth)acrylate such as EO-modified glycerol(meth)acrylate, PO-modified glycerol tri(meth)acrylate, pentaerythritol tri(meth)acrylate, EO-modified phosphoric acid tri(meth)acrylate, trimethylolpropane tri(meth)acrylate, caprolactone-modified trimethylolpropane tri(meth)acrylate, HPA-modified trimethylolpropane tri(meth)acrylate, (EO)- or (PO)-modified trimethylolpropane tri(meth)acrylate, alkyl-modified dipentaerythritol tri(meth)acrylate, tris(acryloxyethyl)isocyanurate, and tris(methacryloxyethyl)isocyanurate;
tetrafunctional (meth)acrylate such as ditrimethylolpropane tetra(meth)acrylate, pentaerythritol ethoxytetra(meth)acrylate, and pentaerythritol tetra(meth)acrylate;
pentafunctional (meth)acrylate such as dipentaerythritol hydroxypenta(meth)acrylate and alkyl-modified dipentaerythritol penta(meth)acrylate; and
hexafunctional (meth)acrylate such as dipentaerythritol hexa(meth)acrylate.

These (meth)acrylate compounds having at least two (meth)acryloyl groups in one molecule can be used alone or in combination of two or more kinds. Among these, the compound (C) preferably has the number of (meth)acryloyl groups in a range of 2 to 6, and is more preferably a compound represented by the following general formula (1) since the active energy ray-curable resin composition capable of forming the cured product having excellent substrate adhesion and scratch resistance can be obtained:

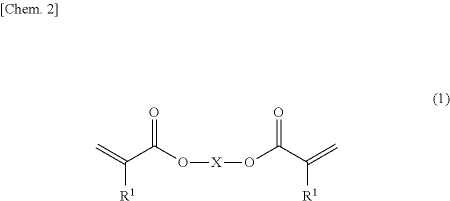

wherein R¹s each independently represent a hydrogen atom or a methyl group, and X represents an alkylene chain having 6 or more carbon atoms.

The content of the compound (C) is preferably in a range of 5 to 40% by mass in the solid content of the active energy ray-curable resin composition since the active energy ray-curable resin composition capable of forming the cured product having excellent substrate adhesion and scratch resistance can be obtained.

Examples of the photopolymerization initiator (D) include photo radical polymerization initiators such as 1-hydroxycyclohexylphenyl ketone, 2-hydroxy-2-methyl-1-phenylpropan-1-one, 1-[4-(2-hydroxyethoxy)phenyl]-2-hydroxy-2-methyl-1-propan-1-one, thioxanthone and thioxanthone derivatives, 2,2′-dimethoxy-1,2-diphenylethan-1-one, diphenyl(2,4,6-trimethoxybenzoyl) phosphine oxide, 2,4,6-trimethylbenzoyl diphenyl phosphine oxide, bis(2,4,6-trimethylbenzoyl)phenylphosphine oxide, 2-methyl-1-(4-methylthiophenyl)-2-morpholinopropan-1-one, 2-benzyl-2-dimethylamino-1-(4-morpholinophenyl)-1-butanone, and benzophenone and benzophenone derivatives.

Examples of commercially available of the photopolymerization initiator (D) include “Omnirad 1173”, “Omnirad 184”, “Omnirad 127”, “Omnirad 2959”, “Omnirad 369”, “Omnirad 379”, “Omnirad 907”, “Omnirad 4265” Omnirad 1000″, “Omnirad 651”, “Omnirad TPO”, “Omnirad 819”, “Omnirad 2022”, “Omnirad 2100”, “Omnirad 754”, “Omnirad 784”, “Omnirad 500”, “Omnirad 81”, and “Omnirad-BP Flakes” (manufactured by IGM Resins B.V.); “KAYACURE DETX”, “KAYACURE MBP”, “KAYACURE DMBI”, “KAYACURE EPA”, and “KAYACURE OA” (manufactured by Nippon Kayaku Co., Ltd.); “Vicure 10” and “Vicure 55” (manufactured by Seqens Chemical Company); “Trigonal P1” (manufactured by Akzo Nobel N.V.), “SANDORAY 1000” (manufactured by SANDOZ Corporation); “DEAP” (manufactured by Upjohn Chemical Company); “Quantacure PDO”, “Quantacure ITX”, and “Quantacure EPD” (manufactured by Ward Blenkinsop & CO., LTD.); and Runtecure 1104 (manufactured by Runtec Chemical Co., Ltd.). These photopolymerization initiators can be used alone or in combination of two or more kinds. Among these, the photopolymerization initiator is preferably benzophenone and benzophenone derivatives since the active energy ray-curable resin composition capable of forming the cured product having excellent substrate adhesion and scratch resistance can be obtained.

The photopolymerization initiator can also be used in combination with a photosensitizer such as an amine compound, a urea compound, a sulfur-containing compound, a phosphorus-containing compound, a chlorine-containing compound, and a nitrile compound.

The amount of the photopolymerization initiator used is preferably in a range of 0.05 to 20 parts by mass and more preferably in a range of 0.1 to 10 parts by mass based on 100 parts by mass of the component excluding an organic solvent in the active energy ray-curable composition of the present invention.

The active energy ray-curable resin compositions of the present invention can also be used in combination with other resin components having active energy ray curability other than the compound (C) within the range not impairing the effects of the present invention. The total content of the inorganic microparticles (A), the inorganic microparticles (B), and the compound (C) is preferably 50% by mass or more in the solid content of the active energy ray-curable resin composition.

Examples of other resin components described above having active energy ray curability include other (meth)acrylate resins (E) other than the compound (C). Examples of other (meth)acrylate resins (E) described above include a dendrimer-type (meth)acrylate resin (E1), an acrylic (meth)acrylate resin (E2), and an epoxy (meth)acrylate resin (E3). These other (meth)acrylate resins (E) can be used alone or in combination of two or more kinds.

The dendrimer-type (meth)acrylate resin (E1) refers to a resin having a regular multibranched structure and (meth)acryloyl groups at the end of each branched chain, and is called a dendrimer type as well as hyperbranched type, star polymer, or the like. Such compounds include, for example, compounds represented by the following structural formulas (3-1) to (3-8), but are not limited thereto. Any resins can be used as long as the resins have a regular multibranched structure and (meth)acryloyl groups at the end of each branch chain:

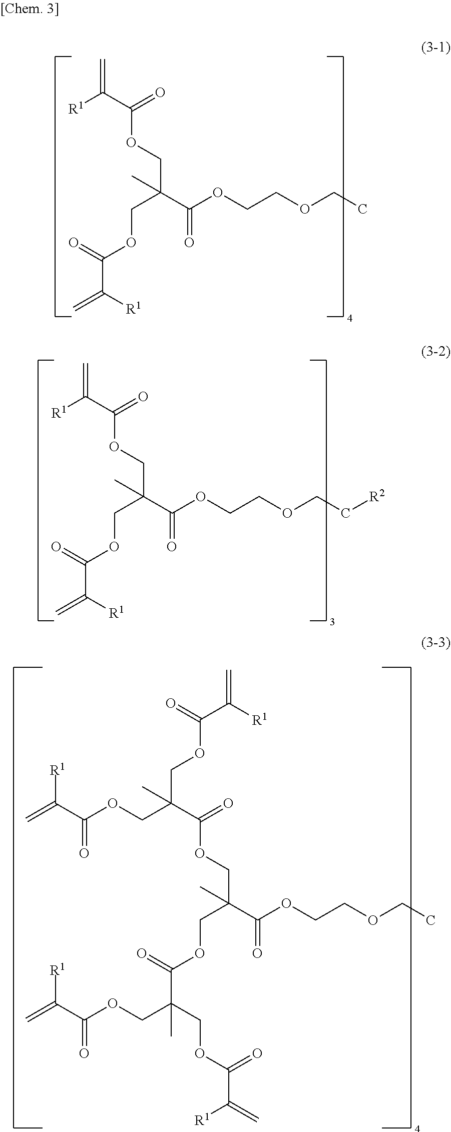

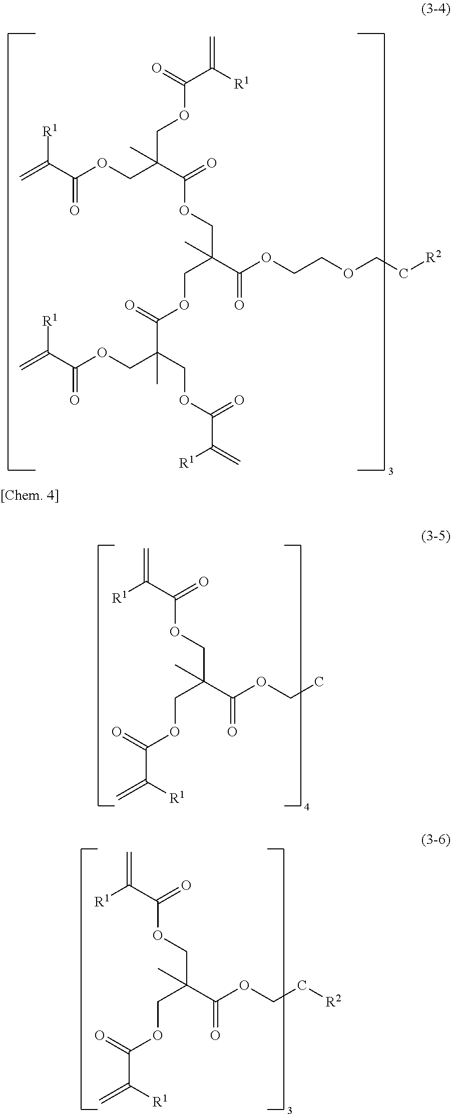

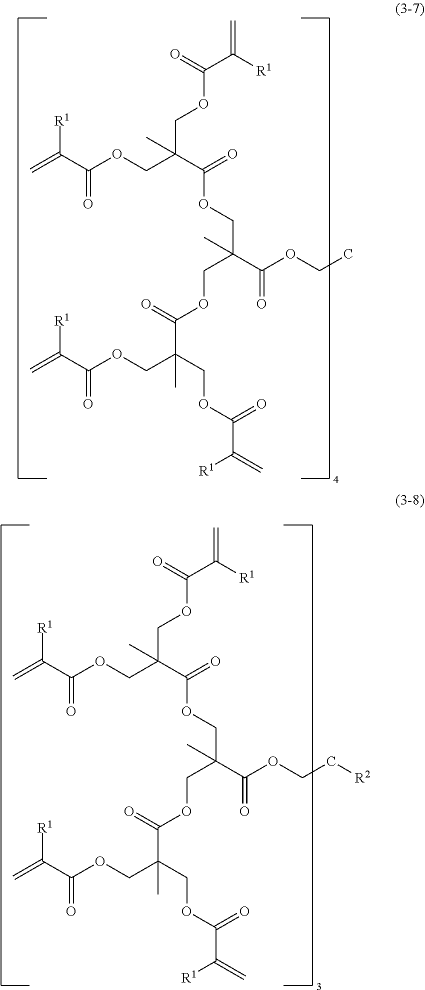

wherein R¹ represents a hydrogen atom or a methyl group and R² represents a hydrocarbon group having 1 to 4 carbon atoms.

Examples of commercially available products of the dendrimer-type (meth)acrylate resin (E1) include “Viscote #1000” [weight average molecular weight (Mw): 1,500 to 2,000, average number of (meth)acryloyl group per molecule: 14], “Viscote 1020” [weight average molecular weight (Mw): 1,000 to 3,000], and “SIRIUS 501” [weight average molecular weight (Mw): 15,000 to 23,000] manufactured by OSAKA ORGANIC CHEMICAL INDUSTRY LTD., “SP-1106” [weight average molecular weight (Mw): 1, 630, average number of (meth)acryloyl group per molecule: 18] manufactured by Miwon Specialty Chemical Co., Ltd., “CN2301” and “CN2302” [average number of (meth)acryloyl groups per molecule: 16], “CN2303” [average number of (meth)acryloyl groups per molecule: 6], and “CN2304” [average number of (meth)acryloyl groups per molecule: 18] manufactured by Sartomer Company Inc., “Esdrimer HU-22” manufactured by NIPPON STEEL & SUMIKIN CHEMICAL CO., LTD., “A-HBR-5” manufactured by SHIN-NAKAMURA CHEMICAL CO., LTD., “New Frontier R-1150” manufactured by DKS Co. Ltd., and “Hypertech UR-101” manufactured by Nissan Chemical Corporation.

The dendrimer-type (meth)acrylate resin (E1) preferably has the weight average molecular weight (Mw) in a range of 1,000 to 30,000. The average number of (meth)acryloyl groups per molecule is preferably in a range of 5 to 30.

The acrylic (meth)acrylate resin (E2) includes, for example, one obtained by introducing a (meth)acryloyl group into an acrylic resin intermediate which is obtained by polymerizing a (meth)acrylate compound (a) having a reactive functional group such as a hydroxyl group, a carboxyl group, an isocyanate group, and a glycidyl group as an essential component by further reacting with a (meth)acrylate compound (B) having a reactive functional group capable of reacting with these functional groups.

Examples of the (meth)acrylate compound (a) having a reactive functional group include a hydroxyl group-containing (meth)acrylate monomer such as hydroxyethyl (meth)acrylate and hydroxypropyl (meth)acrylate; a carboxyl group-containing (meth)acrylate monomer such as (meth)acrylic acid; an isocyanate group-containing (meth)acrylate monomer such as 2-acryloyloxyethyl isocyanate, 2-methacryloyloxyethyl isocyanate, and 1,1-bis(acryloyloxymethyl)ethyl isocyanate; and glycidyl group-containing (meth)acrylate monomer such as glycidyl (meth)acrylate and 4-hydroxybutyl acrylate glycidyl ether. These can be used alone or in combination of two or more kinds.

The acrylic resin intermediate may be one obtained by copolymerizing other polymerizable unsaturated group-containing compounds as needed, in addition to the (meth)acrylate compound (a). Examples of other polymerizable unsaturated group-containing compounds include (meth)acrylic acid alkyl esters such as methyl (meth)acrylate, ethyl (meth)acrylate, propyl (meth)acrylate, butyl (meth)acrylate, and 2-ethylhexyl (meth)acrylate; alicyclic structure-containing (meth)acrylates such as cyclohexyl (meth)acrylate, isoboronyl (meth)acrylate, and dicyclopentanyl (meth)acrylate; aromatic ring-containing (meth)acrylates such as phenyl (meth)acrylate, benzyl (meth)acrylate, and phenoxyethyl acrylate; silyl group-containing (meth)acrylates such as 3-methacryloxypropyltrimethoxysilane; and styrene derivatives such as styrene, α-methylstyrene, and chlorostyrene. These can be used alone or in combination of two or more kinds.

The acrylic resin intermediates can be produced in the same way as general acrylic resins. As an example of production conditions, for example, the acrylic resin intermediates can be produced by polymerizing various monomers in the temperature range of 60° C. to 150° C. in the presence of a polymerization initiator. Examples of polymerization methods include a bulk polymerization method, a solution polymerization method, a suspension polymerization method, and an emulsion polymerization method. Examples of the polymerization modes include random copolymers, block copolymers, and graft copolymers. When a solution polymerization method is performed, ketone solvents such as methyl ethyl ketone and methyl isobutyl ketone, and glycol ether solvents such as propylene glycol monomethyl ether, propylene glycol dimethyl ether, propylene glycol monopropyl ether, and propylene glycol monobutyl ether can be preferably used.

The (meth)acrylate compound (β) is not particularly limited as long as the (meth)acrylate compound (β) can react with the reactive functional group included in the (meth)acrylate compound (α), but from the viewpoint of reactivity, the following combinations are preferred. That is, when hydroxyl group-containing (meth)acrylate is used as the (meth)acrylate compound (α), isocyanate group-containing (meth)acrylate is preferably used as the (meth)acrylate compound (β). When carboxyl group-containing (meth)acrylate is used as the (meth)acrylate compound (α), glycidyl group-containing (meth)acrylate is preferably used as the (meth)acrylate compound (β). When isocyanate group-containing (meth)acrylate is used as the (meth)acrylate compound (α), hydroxyl group-containing (meth)acrylate is preferably used as the (meth)acrylate compound (β). When glycidyl group-containing (meth)acrylate is used as the (meth)acrylate compound (α), carboxyl group-containing (meth)acrylate is preferably used as the (meth)acrylate compound (β). The (meth)acrylate compound (β) can be used alone or in combination with two or more kinds.

As for the reaction of the acrylic resin intermediate with the (meth)acrylate compound (β), for example, when the reaction is an esterification reaction, an example method uses, in a temperature range of 60 to 150° C., an esterification catalyst such as triphenylphosphine as appropriate. When the reaction is a urethane reaction, a method such as reacting the acrylic resin intermediate while the compound (β) is added dropwise in a temperature range of 50 to 120° C. may be used. As for a reaction ratio between the acrylic resin intermediate and the (meth)acrylate compound (β), the (meth)acrylate compound (β) is preferably used in a range of 1.0 to 1.1 moles based on 1 mole of the number of functional groups in the acrylic resin intermediate.

Examples of the epoxy (meth)acrylate resin (E3) include one obtained by reacting an epoxy resin with (meth)acrylic acid or its anhydride. Examples of the epoxy resins include diglycidyl ethers of divalent phenols such as hydroquinone and catechol; diglycidyl ethers of biphenol compounds such as 3,3′-biphenyl diol and 4,4′-biphenyl diol; bisphenol A epoxy resins such as a bisphenol A epoxy resin, a bisphenol B epoxy resin, a bisphenol F epoxy resin, and a bisphenol S epoxy resin; polyglycidyl ethers of naphthol compounds such as 1,4-naphthalenediol, 1,5-naphthalenediol, 1,6-naphthalenediol, 2,6-naphthalenediol, and 2,7-naphthalenediol, binaphthol, bis(2,7-dihydroxynaphthyl) methane; triglycidyl ethers such as 4,4′,4″-methylidine trisphenol; and novolac epoxy resins such as a phenolic novolac epoxy resin and a cresol novolac resin; (poly)oxyalkylene-modified products in which (poly)oxyalkylene chains such as (poly)oxyethylene chains, (poly)oxypropylene chains, and (poly)oxytetramethylene chains are introduced into the molecular structure of the above-mentioned various epoxy resins; and lactone-modified products in which a (poly)lactone structure is introduced into the molecular structure of the above-mentioned various epoxy resins.

The active energy ray-curable resin composition of the present invention may also include various additives such as ultraviolet absorbers, polymerization inhibitors, antioxidants, organic solvents, inorganic fillers or polymer microparticles, pigments, defoaming agents, viscosity adjusters, leveling agents, flame retardants, and storage stabilizers, as needed.

Examples of the ultraviolet absorbers include triazine derivatives such as 2-[4-{(2-hydroxy-3-dodecyloxypropyl)oxy]-2-hydroxyphenyl]-4,6-bis(2,4-dimethylphenyl)-1,3,5-triazine, and 2-[4-{(2-hydroxy-3-tridecyloxypropyl)oxy-2-hydroxyphenyl]-4,6-bis(2,4-dimethylphenyl)-1,3,5-triazine, 2-(2′-xanthene carboxy-5′-methylphenyl)benzotriazole, 2-(2′-o-nitrobenzyloxy-5′-methylphenyl)benzotriazole, 2-xanthene carboxy-4-dodecyloxybenzophenone, and 2-o-nitrobenzyloxy-4-dodecyloxybenzophenone. These ultraviolet absorbers can be used alone or in combination of two or more kinds.

Examples of the polymerization inhibitors include phenol compounds such as p-methoxyphenol, p-methoxycresol, 4-methoxy-1-naphthol, 4,4′-dialkoxy-2,2′-bi-1-naphthol, 3-(N-salicyloyl)amino-1,2,4-triazole, N′1, N′12-bis(2-hydroxybenzoyl)dodecanedihydrazide, styrenated phenol, N-isopropyl-N′-phenylbenzene-1,4-diamine, and 6-ethoxy-2,2,4-trimethyl-1,2-dihydroquinoline; quinone compounds such as hydroquinone, methylhydroquinone, p-benzoquinone, methyl-p-benzoquinone, 2,5-diphenylbenzoquinone, 2-hydroxy-1,4-naphthoquinone, anthraquinone, and diphenoquinone; amine compounds such as melamine, p-phenylenediamine, 4-aminodiphenylamine, N, N′-diphenyl-p-phenylenediamine, N-i-propyl-N′-phenyl-p-phenylenediamine, N-(1,3-dimethylbutyl)-N′-phenyl-p-phenylenediamine, diphenylamine, 4,4′-dicumyl-diphenylamine, 4,4′-dioctyl-diphenylamine, poly(2,2,4-trimethyl-1,2-dihydroquinoline), styrenated diphenylamine, reaction products of styrenated diphenylamine with 2,4,4-trimethylpentene, and reaction products of diphenylamine with 2,4,4-trimethylpentene; thioether compounds such as phenothiazine, distearylthiodipropionate, 2,2-bis({[3-(dodecylthio)propionyl]oxy}methyl)-1,3-propanediyl=bis[3-(dodecylthio)propionate], and ditridecan-1-yl=3,3′-sulfanediyl dipropanoate; nitroso compounds such as N-nitrosodiphenylamine, N-nitrosophenylnaphthylamine, p-nitrosophenol, nitrosobenzene, p-nitrosodiphenylamine, α-nitroso-β-naphthol, etc., N, N-dimethyl p-nitrosoaniline, p-nitrosodiphenylamine, p-nitron dimethylamine, p-nitron-N, N-diethylamine, N-nitrosoethanolamine, N-nitrosodi-n-butylamine, N-nitroso-N-n-butyl-4-butanolamine, N-nitroso-diisopropanolamine, N-nitroso-N-ethyl-4-butanolamine, 5-nitroso-8-hydroxyquinoline, N-nitrosomorpholine, N-nitroso-N-phenylhydroxylamine ammonium salt, nitrosobenzene, N-nitroso-N-methyl-p-toluenesulfonamide, N-nitroso-N-ethylurethane, N-nitroso-N-n-propylurethane, 1-nitroso-2-naphthol, 2-nitroso-1-naphthol, sodium 1-nitroso-2-naphthol-3,6-sulfonate, sodium 2-nitroso-1-naphthol-4-sulfonate, 2-nitroso-5-methylaminophenol hydrochloride, and 2-nitroso-5-methylaminophenol hydrochloride; phosphite compounds such as esters of phosphoric acid and octadecane-1-ol, triphenylphosphite, 3,9-dioctadecan-1-yl-2,4,8,10-tetraoxa-3,9-diphosphaspiro[5.5]undecane, trisnonylphenyl phosphite, phosphorous acid-(1-methylethylidene)-di-4,1-phenylenetetra-C12-15-alkyl ester, 2-ethylhexyl=diphenyl=phosphite, diphenylisodecyl phosphite, triisodecyl=phosphite, and tris(2,4-di-tert-butylphenyl) phosphite; zinc compounds such as zinc bis(dimethyldithiocarbamat-κ (2) S,S′), zinc diethyldithiocarbamate, and zinc dibutyl⋅dithiocarbamate; nickel compounds such as nickel bis(N,N-dibutylcarbamodithioat-S,S′); and sulfur compounds such as 1,3-dihydro-2H-benzoimidazol-2-thione, 4,6-bis(octylthiomethyl)-o-cresol, 2-methyl-4,6-bis[(octane-1-ylsulfanyl)methyl]phenol, dilaurylthiodipropionic acid ester, and distearyl 3,3′-thiodipropionate. These polymerization inhibitors can be used alone or in combination of two or more kinds.

The same compounds as those exemplified as the polymerization inhibitors can be used as the antioxidants, and the antioxidants can be used alone or in combination with two or more kinds.

Examples of commercially available products of the polymerization inhibitors and the antioxidants include “0-1300” and “Q-1301” manufactured by Wako Pure Chemical Industries, Ltd. and “Sumilizer BBM-S” and “Sumilizer GA-80” manufactured by Sumitomo Chemical Co., Ltd.

The same organic solvents as those exemplified as the organic solvents can be used as the organic solvents, and the organic solvents can be used alone or in combination of two or more kinds.

Examples of the inorganic fillers include fused silica, crystalline silica, alumina, silicon nitride, and aluminum hydroxide. These inorganic fillers can be used alone or in combination of two or more kinds.

As the pigments, inorganic and organic pigments that are well-known and commonly used can be employed.

Examples of the inorganic pigments include white pigment, antimony red, bengala, cadmium red, cadmium yellow, cobalt blue, dark blue, ultramarine, carbon black, and graphite. These inorganic pigments can be used alone or in combination of two or more kinds.

Examples of white pigments include titanium dioxide, zinc oxide, magnesium oxide, zirconium oxide, aluminum oxide, barium sulfate, silica, talc, mica, aluminum hydroxide, calcium silicate, aluminum silicate, hollow resin particles, and zinc sulfide. These white pigments can be used alone or in combination of two or more kinds.

Examples of the organic pigments include quinacridone pigments, quinacridonequinone pigments, dioxazine pigments, phthalocyanine pigments, anthrapyrimidine pigments, anthanthrone pigments, indanthrone pigments, flavanthrone pigments, perylene pigments, diketopyrrolopyrrole pigments, perinone pigments, quinophthalone pigments, anthraquinone pigments, thioindigo pigments, benzimidazolone pigments, and azo pigments. These organic pigments can be used alone or in combination of two or more kinds.

Examples of the defoamers include silicone-based defoamers, polyether-based defoamers, and fatty acid ester-based defoamers. These defoamers can be used alone or in combination of two or more kinds.

Examples of the viscosity modifiers include acrylic polymers and synthetic rubber latex that can be thickened by adjusting to alkalinity, urethane resins that can be thickened by molecular association, hydroxyethyl cellulose, carboxymethyl cellulose, methyl cellulose, polyvinyl alcohol, hydrogenated castor oil, amide wax, polyethylene oxide, metallic soap, and dibenzylidene sorbitol. These viscosity adjusters can be used alone or in combination of two or more kinds.

Examples of the leveling agents include silicone-based compounds, acetylene diol-based compounds, and fluorine-based compounds. These leveling agents can be used alone or in combination of two or more kinds.

Examples of the flame retardants include inorganic phosphorus compounds such as red phosphorus, ammonium phosphate such as monoammonium phosphate, diammonium phosphate, triammonium phosphate, and ammonium polyphosphate, and amide phosphate; organic phosphorus compounds such as phosphate ester compounds, phosphonic acid compounds, phosphinic acid compounds, phosphine oxide compounds, phosphorane compounds, organic-based nitrogen-containing phosphorus compounds, cyclic organophosphorus compounds such as 9,10-dihydro-9-oxa-10-phosphaphenanthrene-10-oxide, 10-(2,5-dihydrooxyphenyl)-10H-9-oxa-10-phosphaphenanthrene-10-oxide, and 10-(2,7-dihydroxynaphthyl)-10H-9-oxa-10-phosphaphenanthrene-10-oxide, and derivatives obtained by reacting it with compounds such as epoxy resins and phenol resins; nitrogen-based flame retardants such as triazine compounds, cyanuric acid compounds, isocyanuric acid compounds, and phenothiazine; silicone-based flame retardants such as silicone oils, silicone rubbers, and silicone resins; and inorganic flame retardants such as metal hydroxides, metal oxides, metal carbonate compounds, metal powders, boron compounds, and low-melting point glass. These flame retardants can be used alone or in combination of two or more kinds.

The cured product of the present invention can be obtained by irradiating the active energy ray-curable resin composition with an active energy ray. Examples of the active energy rays include ionizing radiation such as ultraviolet rays, electron beams, α-rays, β-rays, and γ-rays. When ultraviolet rays are used as the active energy ray, the irradiation may be performed under an inert gas atmosphere such as nitrogen gas or under an air atmosphere in order to efficiently perform the curing reaction by ultraviolet rays.

As an ultraviolet ray generation source, ultraviolet lamps are commonly used for practical and economical reasons. Specific examples include low-pressure mercury lamps, high-pressure mercury lamps, super high-pressure mercury lamps, xenon lamps, gallium lamps, metal halide lamps, sunlight, and LEDs.

The integrated light intensity of the active energy ray is not particularly limited, but is preferably from 0.1 to 50 kJ/m², and more preferably from 0.3 to 20 KJ/m². When the integrated light intensity is within the above range, the generation of uncured portions can be prevented or suppressed, which is therefore preferable.

The irradiation with the active energy rays may be performed in one step or in two or more steps.

The laminate of the present invention has a cured coating film of the active energy ray-curable resin composition on one or both sides of a substrate, and can be obtained by applying the active energy ray-curable resin composition onto the substrate and curing it by irradiation with an active energy beam.

Examples of the substrates include cyclic olefin-based substrates and linear olefin-based substrates. The substrates may be in a film form.

Examples of methods for forming the cured coating film include a coating method, a transferring method, and a sheet bonding method.

The coating method is a method in which the active energy ray-curable resin composition is spray-coated or applied to the molded product as a topcoat using printing equipment such as a curtain coater, a roll coater, and a gravure coater, and then cured by irradiation with an active energy beam.

The transferring method is a method of bonding a transfer material obtained by bonding the above-mentioned active energy ray-curable resin composition on a mold-releasing base sheet to the surface of a molded product, peeling off the base sheet to transfer the topcoat to the surface of the molded product, and then irradiating it with active energy rays to be cured, or a method of bonding the transfer material to the surface of a molded product, irradiating it with the active energy rays to be cured, and then peeling off the base sheet, thereby transferring the topcoat to the surface of the molded product.

The sheet bonding method is a method of forming a protective layer on the surface of a molded product by bonding a protective sheet having a coating film made of the curable composition on a base sheet, or a protective sheet having a coating film made of the curable composition and a decorative layer on a base sheet to a plastic molded product.

Specific examples of the sheet bonding method include a method of bonding the base sheet of a sheet for forming a protective layer, which has been produced in advance, to the molded product, and then thermosetting it by heating to cross-link and cure a B-staged resin layer (post-bonding method) or a method in which the sheet for forming a protective layer is placed in a molding die, the resin is injected into a cavity to fill it, thereby obtaining a resin molded product and at the same time, its surface is bonded to the sheet for forming a protective layer, and the resin layer is then cross-linked and cured by thermosetting by heating (simultaneous molding and bonding method).

When a film-like cyclic olefin-based substrate or a linear olefin-based material is used as the substrate, the application amount is preferably adjusted so that the film thickness after curing is in a range of 1 to 100 μm when applying the active energy ray-curable resin composition of the present invention to the film-like cyclic olefin-based substrate or the linear olefin-based substrate. Examples of the coating methods at this time include bar coater coating, die coat coating, spray coat coating, curtain coat coating, meyer bar coating, air knife coating, gravure coating, reverse gravure coating, offset printing, flex printing, and screen printing methods. When the active energy ray-curable composition of the present invention includes the organic solvents, it is preferable to heat the organic solvents for several tens of seconds to several minutes under a condition of 80 to 150° C. after application to volatilize the organic solvents, and then irradiate the active energy ray-curable composition with active energy rays to cure.

The laminate of the present invention may have other layer configurations in addition to the cured coating film made of the active energy ray-curable resin composition. The method for forming these various layer configurations is not particularly limited and, for example, the resin materials may be directly applied to form the layers, or the layers may be pre-prepared in a sheet form and bonded together using an adhesive.

The article of the present invention has the laminate on its surface. Examples of the articles include plastic molded products such as cell phones, home appliances, automobile interior and exterior materials, and office automation equipment.

### EXAMPLE

The present invention will be described more specifically below based on Examples and Comparative Examples. The present invention is not limited to Examples listed below.

In this Example, a weight average molecular weight (Mw) means a value measured under the following conditions using gel permeation chromatography (GPC).
Measuring device; “HLC-8220” manufactured by Tosoh Corporation
Column; “Guard Column Hxx-H” manufactured by Tosoh Corporation
   “TSKgel G5000HXL” manufactured by Tosoh Corporation
   “TSKgel G4000HXL” manufactured by Tosoh Corporation
   “TSKgel G3000HXL” manufactured by Tosoh Corporation
   “TSKgel G2000HXL” manufactured by Tosoh Corporation Detector; Refractive index detector (RI)
Data processing: “SC-8010” by Tosoh Corporation
Measuring conditions: Column temperature 40° C.
   Solvent Tetrahydrofuran
   Flow rate 1.0 ml/min
Standard; Polystyrene
Sample; 0.4% by mass tetrahydrofuran solution in terms of the resin solid content, filtered through a microfilter (100 μl)

### Example 1: Preparation of Active Energy Ray-Curable Resin Composition (1)

By blending 23.3 parts by mass of silica microparticles having a methacryloyl group on the particle surface (“PGM-AC-4130Y” manufactured by Nissan Chemical Corporation, primary average particle diameter: 40 to 50 nm, non-volatile content: 30% by mass), 112.0 parts by mass of silica microparticles without a methacryloyl group on the particle surface (“MEK-ST-ZL” manufactured by Nissan Chemical Corporation, primary average particle size: 70 to 100 nm, non-volatile content 30% by mass), 14.0 parts by mass of a mixture of dipentaerythritol pentaacrylate and dipentaerythritol hexaacrylate (“Lumicure DPA-600” manufactured by Toagosei Co., Ltd.), 7.0 parts by mass of 1,9-nonanediol diacrylate (“Viscote #260” manufactured by OSAKA ORGANIC CHEMICAL INDUSTRY LTD.), 8.4 parts by mass of trimethylolpropane triacrylate (“Aronix M-309” manufactured by Toagosei Co., Ltd.), and 1.4 parts by mass of a photopolymerization initiator (“Omnirad-BP Flakes” manufactured by IGM Resins B.V.) and diluting the resultant product with methyl ethyl ketone, the active energy ray-curable resin composition (1) having a non-volatile content of 30% by mass was obtained.

### Examples 2 to 5: Preparation of Active Energy Ray-Curable Resin Compositions (2) to (5)

The active energy ray-curable resin compositions (2) to (5) were obtained by the same method as in Example 1, using the compositions and formulations shown in Table 1.

### Comparative Examples 1 to 3: Preparation of Active Energy Ray-Curable Resin Compositions (R1) to (R3)

The active energy ray-curable resin compositions (R1) to (R3) were obtained by the same method as in Example 1, using the compositions and formulations shown in Table 1.

The solid content composition ratios of the active energy ray-curable resin compositions (1) to (5) and (R1) to (R3) obtained in Examples and Comparative Examples described above are shown in Table 1.

TABLE 1

| | | Example | Example | Example | Example | Example | Comparative | Comparative | Comparative |
|---|---|---|---|---|---|---|---|---|---|
| | | 1 | 2 | 3 | 4 | 5 | Example 1 | Example 2 | Example 3 |
| Active energy ray-curable resin composition | | (1) | (2) | (3) | (4) | (5) | (R1) | (R2) | (R3) |
| Composition | Inorganic particles (A-1): | 10.0 | 30.0 | 10.0 | | 10.0 | | | 10.0 |
| (part | PGM-AC-4130Y | | | | | | | | |
| | Inorganic particles (A-2): | | | | 10.0 | | | 40.0 | |
| | MEK-AC-2140Z | | | | | | | | |
| | Inorganic particles (B-1): | 48.0 | | 48.0 | 48.0 | 38.0 | | | 20.0 |
| | MEK-ST-ZL | | | | | | | | |
| | Inorganic particles (B-2): | | 28.0 | | | | 60.0 | | |
| | MEK-ST-40 | | | | | | | | |
| | Inorganic particles (B-3): | | | | | 10.0 | | | |
| | SZR-DM | | | | | | | | |
| | (Meth) acrylate compound | 20.0 | 20.0 | 10.0 | 20.0 | 20.0 | | | 30.0 |
| | (C-1): Lumicure DPA-600T | | | | | | | | |
| | (Meth) acrylate compound | 7.0 | 10.0 | 15.0 | 10.0 | 10.0 | | | 20.0 |
| | (C-2): Viscote #260 | | | | | | | | |
| | (Meth) acrylate compound | 12.0 | 12.0 | 17.0 | 12.0 | 12.0 | | 60.0 | 20.0 |
| | (C-3): Aronix M309 | | | | | | | | |
| | (Meth) acrylate compound | | | | | | 40.0 | | |
| | (C-4): KRM 8200 | | | | | | | | |
| | Photopolymerization initiator | 2.0 | 2.0 | 2.0 | 2.0 | 2.0 | 6.0 | 2.0 | 2.0 |
| | (D): Omnirad-BP Flakes | | | | | | | | |
| | Diluting solvent | MEK | MEK | MEK | MEK | MEK | MEK | MEK | MEK |

| | | | | | | | | |
|---|---|---|---|---|---|---|---|---|
| Non-volatile content (% by mass) | 30 | 30 | 30 | 30 | 30 | 30 | 30 | 30 |
| Total content of inorganic particles (A) | 58 | 58 | 58 | 58 | 58 | 60 | 40 | 30 |
| and inorganic particles (B) (% by mass) | | | | | | | | |

All parts by mass described in Table 1 are solid content values.

“PGM-AC-4130Y” in Table 1 represents “PGM-AC-4130Y” manufactured by Nissan Chemical Corporation (silica microparticles having a methacryloyl group on the particle surface, primary average particle diameter: 40 to 50 nm).

“MEK-AC 2140Z” in Table 1 represents “MEK-AC 2140Z” manufactured by NIPPON AEROSIL CO., LTD (silica microparticles, primary average particle size: 12 nm).

“MEK-ST-ZL” in Table 1 represents “MEK-ST-ZL” manufactured by Nissan Chemical Corporation (sol-gel silica, primary average particle size: 12 nm).

“MEK-ST-40” in Table 1 represents “MEK-ST-40” manufactured by Nissan Chemical Corporation (sol-gel silica, primary average particle size: 12 nm).

“SZR-GM” in Table 1 represents “SZR-GM” manufactured by SAKAI CHEMICAL INDUSTRY CO., LTD. (zirconia oxide particle dispersion liquid, average particle diameter 8 nm, methanol solution).

“Lumicure DPA-600” in Table 1 represents “Lumicure DPA-600” manufactured by Toagosei Co., Ltd. (a composition including dipentaerythritol pentaacrylate and dipentaerythritol hexaacrylate in a molar ratio of 40/60).

“Viscote #260” in Table 1 represents “Viscote #260” manufactured by OSAKA ORGANIC CHEMICAL INDUSTRY LTD. (1,9-nonanediol diacrylate).

“Aronix M-309” in Table 1 represents “Aronix M-309” manufactured by Toagosei Co., Ltd. (trimethylolpropane triacrylate).

“KRM 8200” in Table 1 represents “KRM 8200” manufactured by DAICEL-ALLNEX LTD. (hexafunctional urethane acrylate).

“Omnirad-BP Flakes” in Table 1 represents “Omnirad-BP Flakes” manufactured by IGM Resins B.V.

### Examples 6 to 11: Production of Laminate (L-1) to (L-6)

The active energy ray-curable resin composition obtained in Examples 1 to 5 were each applied to a cyclo olefin film substrate having a thickness of 23 μm (“ZeonorFilm ZF14-023” manufactured by ZEON Corporation, film thickness 23 μm) using a bar coater and solvents were dried at 80° C. for 40 seconds. Subsequently, ultraviolet rays were irradiated at 1.2 kJ/m² using an 80 W high-pressure mercury lamp under a nitrogen atmosphere to obtain laminates (L-1) to (L-6) which had a cured coating film having a film thickness of 2 μm on the cyclo olefin film.

### Comparative Examples 4 to 7: Production of Laminates (L-7) to (L-10)

Using the active energy ray-curable resin compositions obtained in Comparative Examples 1 to 3, the laminates (L-7) to (L-10) were obtained in the same manner as in the production of the laminates (L-1) to (L-6) in Examples 5 to 9.

Using the laminates (L-1) to (L-10) obtained in the above Examples and Comparative Examples, the following evaluations were performed.

### [Evaluation Method for Substrate Adhesion (Initial)]

The surface of the cured coating film of the laminate was cut with a cutter knife to create 100 grids of 1 mm×1 mm, a cellophane adhesive tape was stuck on the top of the grids, and then the cellophane adhesive tape was rapidly peeled off, and the number of grids remaining without peeling was counted to evaluate according to the following criteria.

A: The number of remaining grids was 90 or more.

B: The number of remaining grids was less than 90.

### [Evaluation Method for Substrate Adhesion (After Accelerated Lightfastness Test)]

The laminates were irradiated with light for 120 hours at a black panel temperature of 63° C., humidity of 50% RH, and irradiance of 60 W/m² using a weathering tester (“Atlas Weather-Ometer Ci4400” manufactured by Atlas Electrical Devices Co.). The same method was then used as described above for substrate adhesion (initial), and the results were evaluated according to the following criteria.

A: The number of remaining grids was 90 or more.

B: The number of remaining grids was less than 90.

### [Evaluation Method for Scratch Resistance]

An abrasion test was conducted by wrapping a disk-shaped indenter of 2.4 cm in diameter with 0.5 g of steel wool (“Bonster #0000” manufactured by Nippon Steel Wool Co., Ltd.), applying a 1 kg load to the indenter, and making it reciprocate 10 times on the coated surface of the laminate. The haze values of the laminate before and after the abrasion test were measured using “Haze meter HZ-2” manufactured by Suga Test Instruments Co., Ltd., and an evaluation was made using the difference value (dH) between them according to the following criteria. The smaller the difference value (dH), the higher the resistance to abrasion.

A: dH was 1.0 or less.

B: dH was greater than 1.0 and 3.0 or less.

C: dH was greater than 3.0.

TABLE 2

| | | Example | Example | Example | Example | Example | Example |
|---|---|---|---|---|---|---|---|
| | | 6 | 7 | 8 | 9 | 10 | 11 |
| Laminate | | (L-1) | (L-2) | (L-3) | (L-4) | (L-5) | (L-6) |
| Active energy ray-curable | | (1) | (2) | (3) | (4) | (5) | (1) |
| resin composition | | | | | | | |
| Type of substrate | | Substrate 1 | Substrate 1 | Substrate 1 | Substrate 1 | Substrate 1 | Substrate 2 |
| Evaluation | Substrate adhesion | A | A | A | A | A | A |
| items | (initial) | | | | | | |
| | Substrate adhesion | A | A | A | A | A | A |
| | (after accelerated | | | | | | |
| | lightfastness test) | | | | | | |
| | Scratch resistance | A | A | A | A | A | A |

| | | Comparative | Comparative | Comparative | Comparative |
|---|---|---|---|---|---|
| | | Example 4 | Example 5 | Example 6 | Example 7 |
| Laminate | | (L-7) | (L-8) | (L-9) | (L-10) |
| Active energy ray-curable | | (R1) | (R2) | (R3) | (R1) |
| resin composition | | | | | |
| Type of substrate | | Substrate 1 | Substrate 1 | Substrate 1 | Substrate 2 |
| Evaluation | Substrate adhesion | B | B | B | A |
| items | (initial) | | | | |
| | Substrate adhesion | B | B | B | B |
| | (after accelerated | | | | |
| | lightfastness test) | | | | |
| | Scratch resistance | C | A | A | A |

“Substrate 1” in Table 2 represents “ZeonorFilm ZF14-023” manufactured by ZEON Corporation (film thickness 23 μm).

“Substrate 2” in Table 2 represents “ZeonorFilm ZF14-100” manufactured by ZEON Corporation (film thickness 100 μm).

Examples 6 to 11 shown in Table 2 are examples of the laminates using the active energy ray-curable resin compositions of the present invention. It was found that these laminates have excellent substrate adhesion and excellent scratch resistance in the cured product.

On the other hand, Comparative Examples 4 and 7 shown in Table 2 are examples of the laminates using the active energy ray-curable resin compositions without the inorganic particles (A). The laminate obtained in Comparative Example 4 was found to be insufficient in terms of initial substrate adhesion and substrate adhesion after the accelerated lightfastness test, and significantly insufficient in terms of scratch resistance. In addition, it was found that, although the laminate obtained in Comparative Example 7 had excellent initial substrate adhesion and also excellent scratch resistance, it was insufficient in terms of substrate adhesion after the accelerated lightfastness test.

Comparative Example 5 is an example of the laminate using the active energy ray-curable composition without the inorganic particles (B). The laminate was found to be insufficient in terms of initial substrate adhesion and substrate adhesion after the accelerated lightfastness test.

Comparative Example 6 is an example of the laminate using the active energy ray-curable composition in which the total content of the inorganic microparticles (A) and the inorganic microparticles (B) is outside the range of 40 to 90% by mass (30% by mass) in the total mass of the inorganic microparticles (A), the inorganic microparticles (B), and the compound (C). The laminate was found to be insufficient in terms of initial substrate adhesion and substrate adhesion after the accelerated lightfastness test.

1. An active energy ray-curable resin composition comprising:
inorganic microparticles (A) having a (meth)acryloyl group on a particle surface;
inorganic microparticles (B) other than the inorganic microparticles (A);
a compound (C) having two or more (meth)acryloyl groups in one molecule; and
a photopolymerization initiator (D), wherein
a total content of the inorganic microparticles (A) and the inorganic microparticles (B) is in a range of 40 to 90% by mass in a total mass of the inorganic microparticles (A), the inorganic microparticles (B), and the compound (C).

2. The active energy ray-curable resin composition according to claim 1, wherein the inorganic microparticles (A) and the inorganic microparticles (B) are each independently silica and/or zirconium oxide.

3. The active energy ray-curable resin composition according to claim 1, wherein a content of the inorganic microparticles (A) is in a range of 10 to 90% by mass in a total mass of the inorganic microparticles (A) and the inorganic microparticles (B).

4. The active energy ray-curable resin composition according to claim 1, wherein the compound (C) has the number of (meth)acryloyl groups in a range of 2 to 6.

5. The active energy ray-curable resin composition according to claim 1, wherein the compound (C) is a compound represented by the following general formula (1): 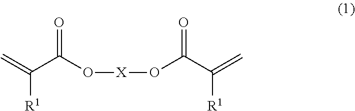
wherein R¹s each independently represent a hydrogen atom or a methyl group, and X represents an alkylene chain having 6 or more carbon atoms.

6. A cured product of the active energy ray-curable resin composition according to claim 1.

7. A laminate comprising a cured coating film of the active energy ray-curable resin composition according to claim 1 on one or both sides of a substrate.

8. The laminate according to claim 7, wherein the substrate is a cyclic olefin-based substrate or a linear olefin-based substrate.

9. The laminate according to claim 7, wherein the substrate is in a film form.

10. An article comprising the laminate according to claim 7 on a surface thereof.
